(19) United States
(12) Patent Application Publication
(10) Pub. No.: US 2017/0266786 A1
(43) Pub. Date: Sep. 21, 2017

(54) DUAL DRIVE HEX SOCKET AND METHOD

(71) Applicant: Malcolm Rydberg, East Greenwich, RI (US)

(72) Inventor: Malcolm Rydberg, East Greenwich, RI (US)

(21) Appl. No.: 15/461,555

(22) Filed: Mar. 17, 2017

Related U.S. Application Data
(63) Continuation-in-part of application No. 29/505,994, filed on May 16, 2016.
(60) Provisional application No. 62/390,054, filed on Mar. 17, 2016.

(51) Int. Cl. B25B 13/06; B25B 23/10

(52) U.S. Cl. CPC B25B 13/065; B25B 23/108

(57) ABSTRACT

A dual drive hex socket is disclosed, that includes a body having a first drive end and a driven end. The first drive end has a socket configured and arranged to receive an end of a socket drive. The driven end is configured and arranged to receive a head of a bolt. A drive surface is formed on an outer surface of the body, where the drive surface provides an engagement point for application of torsional force to the body. In use, the user may use a socket drive and/or wrench in combination to provide torsional force at two different distinct points to the socket and thereby the head of the bolt. Used in combination, slippage may be prevented of the socket from the head of the bolt in addition to applying superior force to bolt.

### CROSS-REFERENCE TO RELATED APPLICATION

This patent document claims priority to earlier filed U.S. Provisional Application Ser. No. 62/390,054, filed Mar. 17, 2016, and U.S. Design Patent Application Ser. No. 29/505,994, filed Mar. 16, 2016, the contents of which are incorporated herein by reference.

### BACKGROUND OF THE INVENTION

1. Field of the Invention

This patent document relates to a socket construction and, more particularly, to a socket including a hexagonal shape along its length to facilitate being driven by a wrench in addition to a socket drive.

2. Background of the Related Art

Fastener insertion tools utilize a fastener drive tool engaging with a ratchet wrench. The common engaging interface utilizes a square plug projecting from wrench ratcheting head which inserts into a receptacle cavity within a base of the fastener drive tool. Conventionally, hand operated wrench for tightening and loosening hexagonal nuts includes open end wrench, box wrench, adjustable wrench and socket wrench, of which socket wrench requires a set of sockets in various specifications for taking replacement according to the size of nuts or other bolt type fasteners.

The open end wrench has a major defect in its structure because during operation, the torsion from the wrench is only applied to the opposing two points of a quadrangle or hexagonal bolt head or nut, often resulting in either hurting the user from an accidental disengagement between the wrench and the work piece or damaging the bolt head or nut. Although the box wrench has partially solved the problem yet it still has its limit similar to that of the open-end wrench, i.e. the work piece must protrude out of the main body thereof.

Besides, both the open end wrench and the box wrench have to be separately prepared in different sizes in conjunction with the different sizes of the bolt heads and nuts. Accordingly, an adjustable wrench and socket wrench are produced to meet the requirement. However, the adjustable wrench and socket wrench has the same defect as that of the open end wrench in torsion application, and the socket wrench when being driven by only a socket drive may result in an accidental disengagement between the socket and work piece.

### SUMMARY OF THE INVENTION

The dual drive hex socket solves the problems of the prior art by providing s a socket including a hexagonal shape along its entire length to facilitate being driven by a wrench in addition to a socket drive. This feature facilitates the application of driven force at different points along the socket for engagement of the socket in a plurality of access scenarios where having only one wrench engagement point may not be operably acceptable.

### BRIEF DESCRIPTION OF THE DRAWINGS

These and other features, aspects, and advantages of the present invention will become better understood with reference to the following description, appended claims, and accompanying drawings where:

FIG. 1 is a front perspective view of an embodiment of a hex socket;

FIG. 2 is a top view of an embodiment of a hex socket;

FIG. 3 is a bottom view of an embodiment of a hex socket;

FIG. 4 is a front view of an embodiment of a hex socket;

FIG. 5 is a rear view of an embodiment of a hex socket;

FIG. 6 is a left side view of an embodiment of a hex socket;

FIG. 7 is a right side view of an embodiment of a hex socket;

FIG. 8 is an perspective view of an alternative embodiment of a hex socket having varying vertical lengths;

FIG. 9 is a perspective view of an embodiment of a hex socket, illustrating use of the hex socket with a ratchet and a wrench; and

FIG. 10 is a flow chart illustrating the steps of use of the hex socket.

### DESCRIPTION OF THE PREFERRED EMBODIMENT

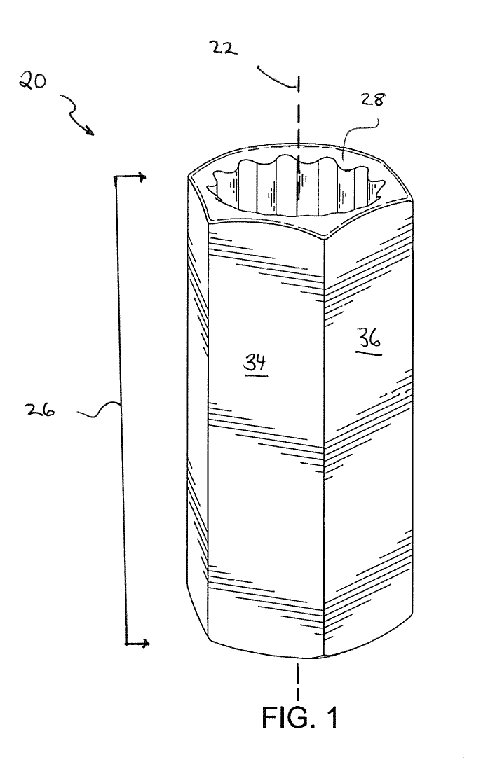

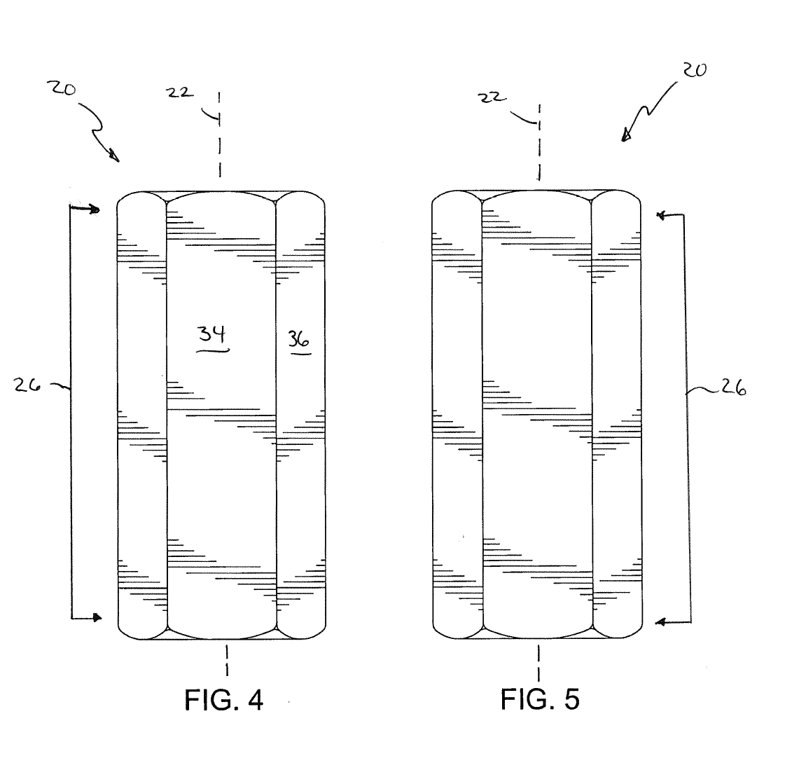

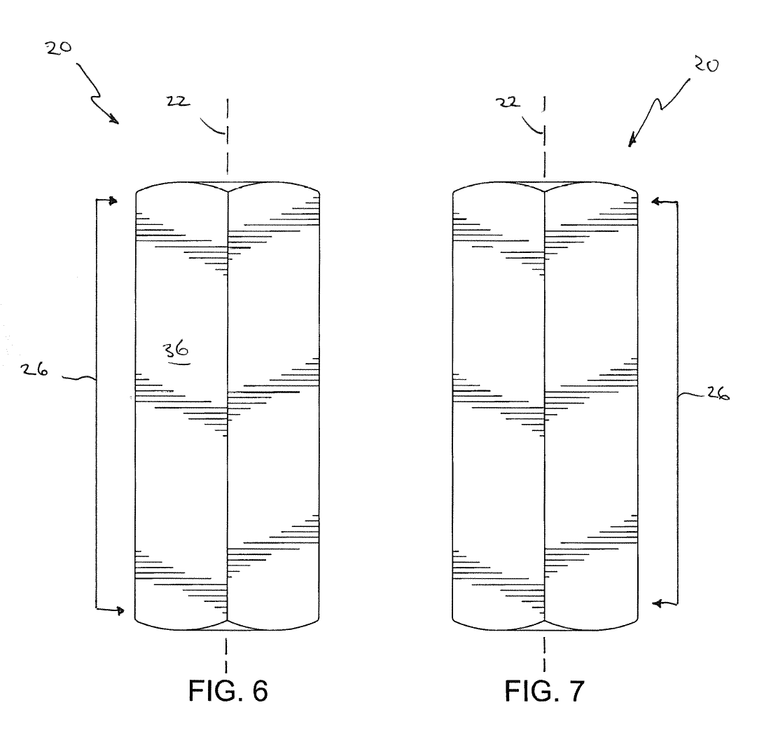

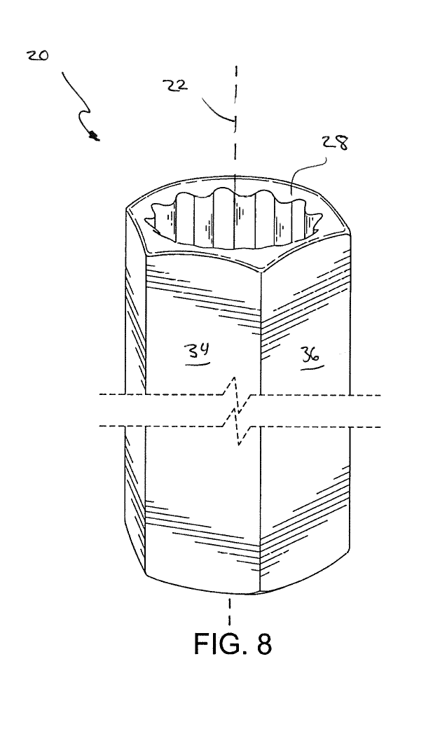

Referring therefore to FIGS. 1-10, a single socket is comprised of a unitary body 20, typically cast or formed by forging, machining or other applicable means. For example, rod stock may be cut to a desired length and then formed by forging or other operations including machining operations.

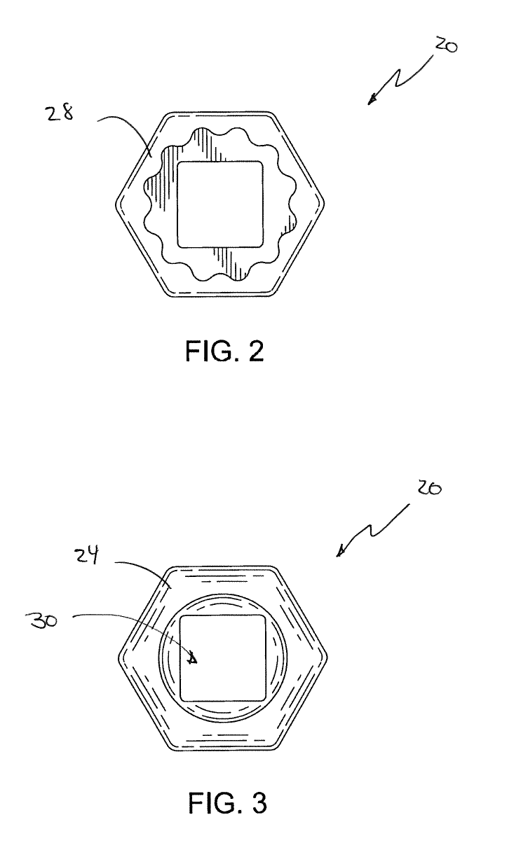

The socket construction includes a unitary, integral body 20 is generally elongate and includes a centerline axis 22. The body 20 includes first drive end 24 (best seen in FIG. 3), a second drive surface 26, and a driven end 28 (best seen in FIG. 2) that are generally symmetrical with respect to the elongate, centerline axis 22.

The first drive end 24 is typically formed to include a recessed, formed drive socket 30 which is typically a square drive socket symmetrical about the centerline axis 22. The internal socket 30 is formed in the manner which is coaxial with a circumferential second drive surface 26 which is typically comprised of a series of drive faces such as faces 34 and 36 which are configured, for example, to have a hexagonal shape which is symmetrical about the centerline axis 22.

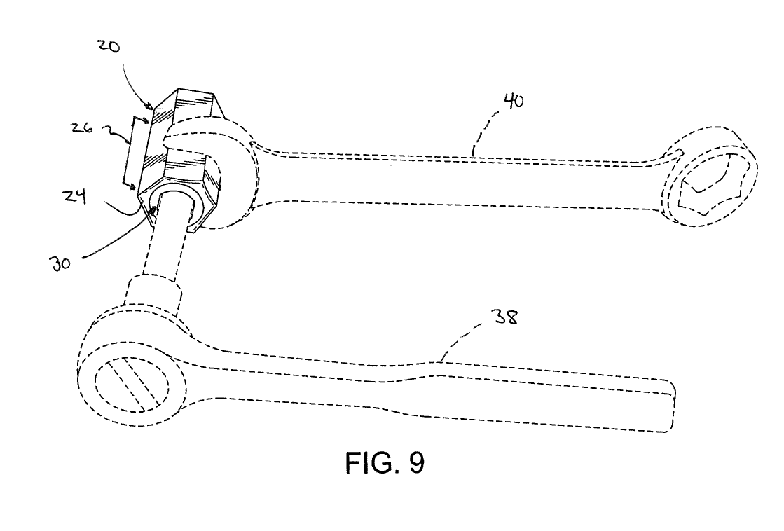

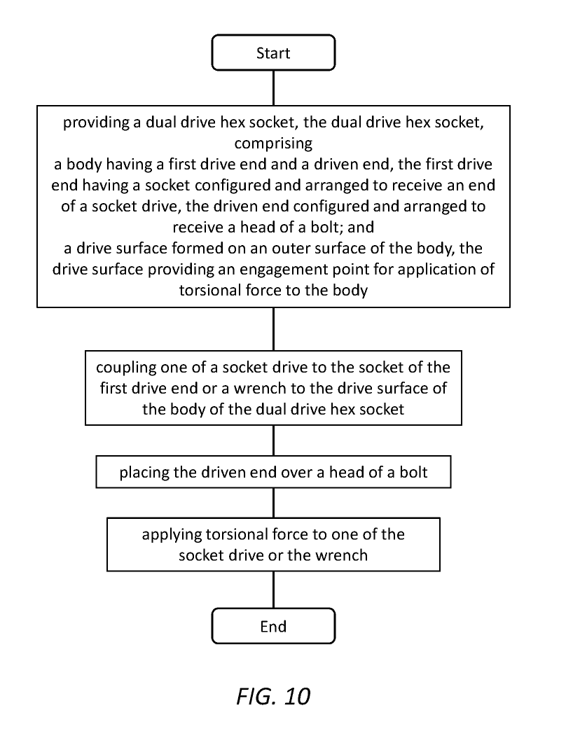

Referring to FIGS. 9 and 10, the driven end 28 is adapted to engage a standard bolt head (not shown) and is configured circumferential recesses as is standard in the art. The socket 30 may be driven by engaging a socket drive 38 square end 38A within the square drive socket 30 or alternatively/concurrently with a hexagonal wrench 40 which may be engaged with the external hexagonal drive faces 34, 36. The series of drive faces 34 and 36 along second drive surface 26 allow wrench 40 engagement end 40A to provide torsional force along a plurality of engagement points along second drive surface 26. This can be especially useful in situations where body 20 is in a “hard to reach” location and multiple access points are required.

Therefore, it can be seen that the present invention provides a unique solution to the problems of prior art socket by providing a socket that has reduced slippage from the head of a bolt, provides an additional point to apply torsional forces to the bolt and is usable with open-end wrenches as well as socket drivers.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A dual drive hex socket, comprising:
a body having a first drive end and a driven end, the first drive end having a socket configured and arranged to receive an end of a socket drive, the driven end configured and arranged to receive a head of a bolt; and
a drive surface formed on an outer surface of the body, the drive surface providing an engagement point for application of torsional force to the body.

2. The hex socket of claim 1, wherein the engagement point of the drive surface comprises a plurality of drive faces.

3. The hex socket of claim 2, wherein the drive faces are arranged in a hexagonal pattern.

4. The hex socket of claim 1, wherein the drive surface extends along the outer surface of the body from the driven end to the first drive end of the body.

5. The hex socket of claim 2, wherein the drive surface extends along the outer surface of the body from the driven end to the first drive end of the body.

6. The hex socket of claim 3, wherein the drive surface extends along the outer surface of the body from the driven end to the first drive end of the body.

7. The hex socket of claim 1, wherein the socket on the first drive end is a square socket.

8. The hex socket of claim 1, wherein the socket on the first drive end is coaxial with a centerline axis of the body.

9. The hex socket of claim 1, wherein the driven end is coaxial with a centerline of the body.

10. The hex socket of claim 1, wherein the body is symmetrical about a centerline axis.

11. A method of applying torsional force to a bolt, comprising:
providing a dual drive hex socket, the dual drive hex socket, comprising:
a body having a first drive end and a driven end, the first drive end having a socket configured and arranged to receive an end of a socket drive, the driven end configured and arranged to receive a head of a bolt; and
a drive surface formed on an outer surface of the body, the drive surface providing an engagement point for application of torsional force to the body;
coupling one of a socket drive to the socket of the first drive end or a wrench to the drive surface of the body of the dual drive hex socket;
placing the driven end over a head of a bolt; and
applying torsional force to one of the socket drive or the wrench;
whereby torsional force is applied to the head of the bolt.

12. The method of claim 11, further comprising coupling a socket drive to the socket of the first drive end of the dual drive hex socket and a wrench to the drive surface of the body.

13. The method of claim 12, further comprising applying torsional force to the socket drive and the wrench.
